(19) United States
(12) Patent Application Publication
(10) Pub. No.: US 2017/0046705 A1
(43) Pub. Date: Feb. 16, 2017

(54) PAYMENT METHOD AND PAYMENT SYSTEM

(71) Applicant: KUANG-CHI INTELLIGENT PHOTONIC TECHNOLOGY LTD., Shenzhen (CN)

(72) Inventors: Ruopeng LIU, Shenzhen (CN); Weicheng XU, Shenzhen (CN); Xudong WANG, Shenzhen (CN); Weizi HUANG, Shenzhen (CN)

(73) Assignee: KUANG-CHI INTELLIGENT PHOTONIC TECHNOLOGY LTD., Shenzhen (CN)

(21) Appl. No.: 15/336,830

(22) Filed: Oct. 28, 2016

Related U.S. Application Data
(63) Continuation of application No. PCT/CN2015/082854, filed on Jun. 30, 2015.

(30) Foreign Application Priority Data
Apr. 30, 2014 (CN) 201410182845.7
Apr. 30, 2014 (CN) 201410182947.9
Apr. 30, 2014 (CN) 201410182949.8
Apr. 30, 2014 (CN) 201410183194.3
Apr. 30, 2014 (CN) 201410183195.8
Apr. 30, 2014 (CN) 201410183908.0

(51) Int. Cl. G06Q 20/40; H04B 10/116; G06Q 20/22; G06Q 20/20; G06Q 20/32; G06Q 20/10

(52) U.S. Cl. CPC G06Q 20/4014; G06Q 20/3223; G06Q 20/102; G06Q 20/227; G06Q 20/206; H04B 10/116; G06Q 2220/00

(57) ABSTRACT

The present disclosure provides a payment method, including: sending, by a payment terminal, identity information to a receiving terminal in the form of a transmitted signal; sending, by the receiving terminal, transaction information to an acquiring platform, where the transaction information includes the identity information; obtaining, by the acquiring platform, payment account information based on the identity information, and sending a payment request to a settlement platform, where the payment account information is information about a first payment account used for payment; and performing, by the settlement platform, settlement in response to the payment request, where the payment request includes the payment account information of the first payment account.

### CROSS REFERENCE TO RELATED APPLICATIONS

This application is a continuation of PCT Application No. PCT/CN2015/082854 filed on Jun. 30, 2015, which claims priority to Chinese patent application No. 201410183195.8 of Apr. 30, 2014; Chinese patent application No. 201410183194.3 of Apr. 30, 2014; Chinese patent application No. 201410183908.0 of Apr. 30, 2014; Chinese patent application No. 201410182845.7 of Apr. 30, 2014; Chinese patent application No. 201410182949.8 of Apr. 30, 2014; and Chinese patent application No. 201410182947.9 of Apr. 30, 2014, all of which are incorporated herein by reference.

### TECHNICAL FIELD

The present disclosure relates to a payment technology, and in particular, to a payment method and a payment system.

### BACKGROUND

Currently, a consumer may swipe a card of a payment account (for example, a credit card, a debit card, or a third-party payment account, a prepaid card issued by a merchant, or an all-in-one card) on a POS end when making a payment for a transaction. This conventional “card swiping” payment method prevents the consumer from carrying plenty of cash, but the consumer still needs to carry or remember the payment account in order to make a payment by swiping a card, which restricts the payment for a transaction. With popularization of the mobile communications technology, people usually carry a mobile terminal. A multimedia function of the mobile terminal is already a standard configuration. For example, many mobile terminals have a signal transmission function. Therefore, using a mobile terminal to implement a payment for a transaction brings great convenience.

A visible light communications technology is a new wireless light communications technology that is developed based on an LED technology. Visible light communication uses frequent flashing of an LED light source for communication. Light represents 1, and absence of light represents 0. A transmission rate of the visible light communication is up to 1000 Mbps. The visible light communication has abundant spectrum resources, which is an incomparable advantage compared with general wireless communication such as microwave communication. In addition, the visible light communication is compatible with any communications protocol and applicable to any environment. In addition, equipment deployment for visible light communication is flexible, convenient and cost-efficient, and is suitable for massive popularized application. A visible light communications system uses visible light to perform near field communication. Because visible light has high directivity and is unable to penetrate an obstacle, the visible light communication is securer than a wireless communication mode. When a mobile terminal has a flash function, using visible light communication of the mobile terminal to implement a payment for a transaction brings great convenience.

### SUMMARY

The following gives an overview of one or more aspects to provide a basic understanding of the aspects. This overview is neither a detailed description on all conceived aspects, nor intended to specify key or decisive elements of all aspects or intended to define the scope of any aspect or all aspects. The only objective of the overview is to give concepts in one or more aspects in a simplified manner to serve as a preamble of subsequent detailed description.

According to one aspect of the present disclosure, a payment method is provided, including: sending, by a payment terminal, identity information to a receiving terminal in the form of a transmitted signal; sending, by the receiving terminal, transaction information to an acquiring platform, where the transaction information includes the identity information; obtaining, by the acquiring platform, payment account information based on the identity information, and sending a payment request to a settlement platform, where the payment account information is information about a first payment account used for payment; and performing, by the settlement platform, settlement in response to the payment request, where the payment request includes the payment account information of the first payment account.

According to another aspect of the present disclosure, a payment method is provided, including: sending, by a payment terminal, identity information to a receiving terminal in the form of a transmitted signal; sending, by the receiving terminal, transaction information to an acquiring platform, where the transaction information includes the identity information; obtaining, by a settlement platform, payment account information based on the identity information from the acquiring platform, where the payment account information is information about a first payment account used for payment; and performing, by the settlement platform, settlement in response to the obtained payment account information of the first payment account.

According to another aspect of the present disclosure, a payment system is provided, including: a payment terminal, where the payment terminal is configured to send identity information in the form of a transmitted signal; a receiving terminal, where the receiving terminal is configured to receive the identity information and send transaction information, where the transaction information includes the identity information; an acquiring platform, where the acquiring platform is configured to receive the transaction information, obtain payment account information based on the identity information, and send a payment request, where the payment account information is information about a first payment account used for payment; and a settlement platform, where the settlement platform is configured to perform settlement in response to the received payment request, where the payment request includes the payment account information of the first payment account.

According to another aspect of the present disclosure, a payment system is provided, including: a payment terminal, where the payment terminal is configured to send identity information in the form of a transmitted signal; a receiving terminal, where the receiving terminal is configured to receive the identity information and send transaction information, where the transaction information includes the identity information; an acquiring platform, where the acquiring platform is configured to upload the identity information received from the receiving terminal; and a settlement platform, where the settlement platform is configured to obtain payment account information based on the identity information from the acquiring platform, and perform settlement in response to the obtained payment account information of a first payment account, where the payment account information is information about the first payment account used for payment.

According to another aspect of the present disclosure, a payment method is provided, including: sending, by a payment terminal, payment identity information to a receiving terminal in the form of a transmitted signal; sending, by the receiving terminal, a transaction request to a settlement platform, where the transaction request includes the payment identity information; and performing, by the settlement platform, settlement based on authentication of the payment identity information.

According to another aspect of the present disclosure, a payment system is provided, including: a payment terminal, where the payment terminal is configured to send payment identity information in the form of a transmitted signal; a receiving terminal, where the receiving terminal is configured to receive the payment identity information and send transaction request, where the transaction request includes the payment identity information; and a settlement platform, where the settlement platform is configured to receive the transaction request and perform settlement based on authentication of the payment identity information.

### BRIEF DESCRIPTION OF DRAWINGS

The foregoing features and advantages of the present disclosure can be better understood after detailed description of the disclosed embodiments is read with reference to the following accompanying drawings. In the accompanying drawings, components are not necessarily plotted proportionally, and components with similar related features or characteristics may have the same or similar marks in the accompanying drawings.

FIG. 1a is a block diagram of a payment system according to a first embodiment of the present disclosure;

FIG. 1b is a block diagram of a payment terminal according to one aspect of the present disclosure;

FIG. 1c is a block diagram of a receiving terminal according to one aspect of the present disclosure;

FIG. 1d is a block diagram of a user management platform according to one aspect of the present disclosure;

FIG. 2 is a block diagram of a payment system according to a second embodiment of the present disclosure;

FIG. 3 is a flowchart of a payment method according to one aspect of the present disclosure;

FIG. 4 is a block diagram of a payment system according to a third embodiment of the present disclosure;

FIG. 5 is a block diagram of a payment system according to a fourth embodiment of the present disclosure;

FIG. 6 is a block diagram of a payment system according to a fifth embodiment of the present disclosure;

FIG. 7 is a flowchart of a payment method according to another aspect of the present disclosure;

FIG. 8 is a block diagram of a payment system according to a sixth embodiment of the present disclosure; and

FIG. 9 is a flowchart of a payment method according to still another aspect of the present disclosure.

### DESCRIPTION OF EMBODIMENTS

The following gives detailed description of the present disclosure with reference to accompanying drawings and specific embodiments. It should be noted that all aspects described below with reference to the accompanying drawings and specific embodiments are merely exemplary, and should not be understood as any limitation on the protection scope of the present disclosure.

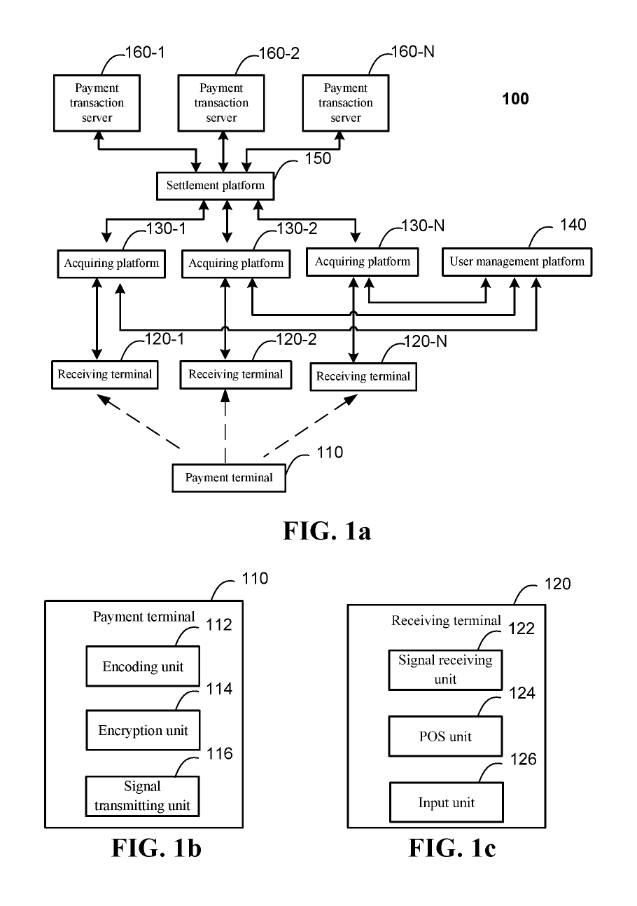

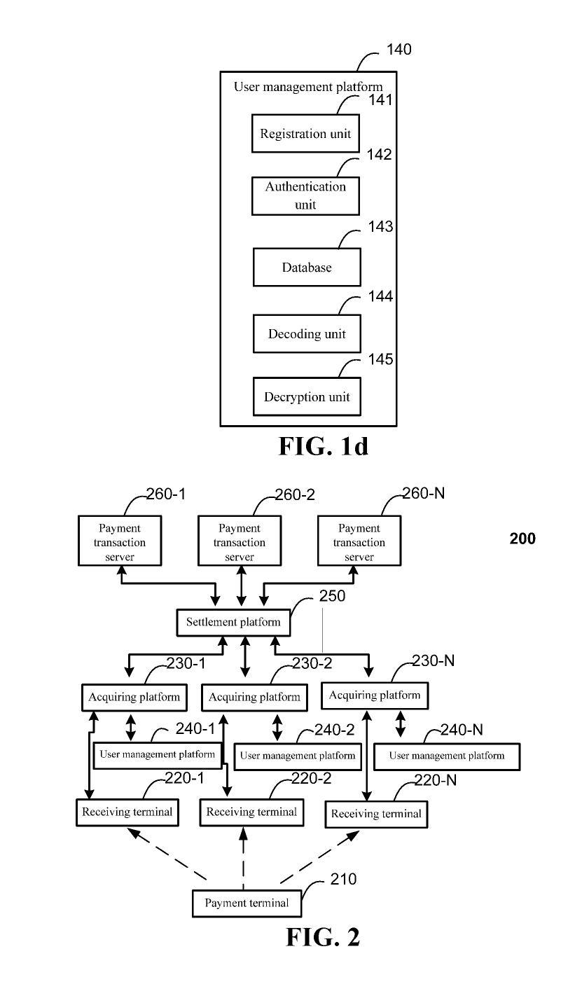

FIG. 1a is a block diagram of a payment system 100 according to a first embodiment of the present disclosure. The payment system 100 may include a payment terminal 110. As shown in FIG. 1b, the payment terminal 110 may be any appropriate portable terminal that includes a signal transmitting unit 116, for example, a cellular phone, a satellite phone, a cordless phone, a personal digital assistant (PDA), a handheld device with a wireless connection capability, a computing device, or other processing devices connected to a wireless modem. The payment terminal 110 may use the signal transmitting unit 116 to communicate with other devices with a signal receiving capability. For example, the signal transmitting unit 116 may be a visible light emitting unit, an acoustic unit, an infrared unit, a WiFi unit, or a radio frequency unit. When the transmitting unit 116 is a visible light emitting unit, the payment terminal 110 may be called a photonic payment terminal, so that light communication between the payment terminal and other devices with a light communication capability can be implemented by using the visible light emitting unit 116. For example, light represents a high level, and absence of light represents a low level. Therefore, the light emitting unit 116 may use a light emitting diode (LED), for example, to emit light regularly in a frequently flashing manner to denote significant signals.

The payment system 100 may include a user management platform 140 to implement user information management. The payment terminal 110 may access the user management platform 140 by using a wireless communications system. The wireless communications system may be CDMA, TDMA, FDMA, OFDMA, SC-FDMA, or other systems. A CDMA system can implement radio technologies such as universal terrestrial radio access (UTRA) and cdma2000. The UTRA includes wideband CDMA (W-CDMA) and other CDMA variants. In addition, the cdma2000 covers IS-2000, IS-95, and IS-856 standards. The TDMA system can implement radio technologies such as Global System for Mobile communications (GSM). An OFDMA system can implement radio technologies such as evolved UTRA (E-UTRA), ultra mobile broadband (UMB), IEEE 802.11 (Wi-Fi), IEEE 802.16 (WiMAX), IEEE 802.20, and Flash-OFDM®.

A user may request to get registered on the user management platform 140 by using the payment terminal 110. As shown in FIG. 1d, the user management platform 140 may include a registration unit 141 for registering an account. In response to a registration request from the payment terminal 110, the registration unit 141 may register an account for the payment terminal 110, and allocate identity information to the account. For example, the identity information may include an identity ID. The identity ID may be stored in the user management platform 140, for example, stored in a database 143 of the user management platform 140. When the payment terminal 110 is a photonic payment terminal, the account may be called a light account, and the identity information may be called photonic identity information. Accordingly, the identity ID may be called a light ID.

After the account is registered, the user may set a corresponding login password, and may use the payment terminal 110 to log in to the account. If the user forgets the login password, the original login password may be regained by using short message authentication, email authentication, identity correlation information authentication or the like, which is well-known by a person skilled in the art.

After logging in to the account, the user may submit a request for binding the payment account to the account and the identity ID. The user may bind multiple payment accounts to the account and the identity ID. The payment account herein may be a bank card, a third-party payment account, a prepaid card, a credit card or the like. The user may submit payment account authentication information of the payment account, for example, a card number, a name of a deposit bank or an issuing bank, a cardholder name, an identity card number, a mobile phone number or the like, to the user management platform 140. The user management platform 140 may send payment account authentication information submitted by the user, directly or indirectly by using an acquiring platform 130 or a settlement platform 150 that is described below, to a payment account issuing institution such as a payment transaction system (also called a payment transaction server) 160 for authentication. Examples of the payment account issuing institution include a payment account bank, a third-party payment institution, a credit card issuing institution, a prepaid card issuing institution, and an urban all-in-one card issuing institution. For example, the user management platform 140 may, according to a specified interface and a specified communications protocol, submit information packaged by the user to an acquiring platform corresponding to the payment account, for example, an acquiring platform 130-n, and the acquiring platform 130-n reports the information to the settlement platform 150 according to the interface and the communications protocol that are provided by the payment transaction system, and receives an authentication prompt fed back by the payment account issuing institution such as a bank, a third-party payment institution, a prepaid card issuing institution, or an urban all-in-one card issuing institution.

If the authentication succeeds, the registration unit 141 may bind the account to the payment account, for example, correlate the identity ID corresponding to the account with the payment account. The user may bind multiple payment accounts to the account, and may set a default payment account, or select, at the time of paying, a corresponding payment account for payment.

Preferably, the identity information may further include an identity password (which may be called a payment password) for authenticating identity information. The payment password may be set by the registration unit 141 in response to a user selection. When the user forgets the payment password, the payment password may be regained or reset by using the payment account correlation information or identity information correlated with the user. The payment password may include a digital password, a gesture password, fingerprint information and the like. The account, the corresponding identity ID, the payment password, and the payment account information of at least one bound payment account may be stored in the database 143. In an instance, multiple payment accounts bound to a specific account and identity ID may be numbered 1 to N. The multiple payment accounts are stored together with the account, the identity ID, and the payment password correlatively, as shown in Table 1.

TABLE 1

| | | | | |
|---|---|---|---|---|
| Account/ | Identity (payment) | 1 | Payment | Payment account |
| identity ID | password | | account 1 | information |
| | | 2 | Payment | Payment account |
| | | | account 2 | information |
| | | . . . | . . . | . . . |
| | | N | Payment | Payment account |
| | | | account N | information |

The payment terminal 110 may implement the account registration request, password setup and the payment account binding operation by using corresponding payment software. The payment software may be installed on the payment terminal 110. For example, the user may start the payment software on the payment terminal 110, and by using the payment software, perform account registration and management, payment account binding, setup of a default payment account, payment account unbinding and the like.

The payment system 100 may further include a receiving terminal 120-n (n=1, 2, . . . N), which is collectively called a receiving terminal 120. The receiving terminal 120-n may be a simple receiving device that is disposed at a merchant and has a communication function, or may be a POS (Point of Sales) machine or a computer that has a communication function and functions such as ticket printing and password input. The receiving terminal 120-n may be correlated with a financial institution, and different receiving terminals are affiliated to different financial institutions. For example, the receiving terminal 120-1 is affiliated to a first financial institution, and the receiving terminal 120-2 is affiliated to a second financial institution. The financial institutions issue their respective payment accounts.

The receiving terminal 120-n corresponds to the acquiring platform 130-n. Similar to the receiving terminal, the acquiring platform 130-n may also be correlated with a financial institution, and different acquiring platforms are affiliated to different financial institutions. For example, the acquiring platform 130-1 is affiliated to a first financial institution, and the acquiring platform 130-2 is affiliated to a second financial institution. The acquiring platform 130-n is communicationally coupled with a public user management platform 140.

The payment system 100 may further include a corresponding payment transaction system 160-n. Similarly, the payment transaction system 160-n is correlated with a financial institution, and different payment transaction systems are affiliated to different financial institutions. For example, the payment transaction system 160-1 is affiliated to a first financial institution, and the payment transaction system 160-2 is affiliated to a second financial institution.

The receiving terminal 120-n may be an integrated POS machine that includes a signal receiving unit. Alternatively, the receiving terminal may also be a conventional POS machine connected to a stand-alone signal receiving module. For example, the conventional POS machine may communicate with the signal receiving module by using a communications interface such as an RS232 or USB interface, or communicate with the signal receiving module by using a wireless network. The following uses a stand-alone POS machine architecture as an example to describe the receiving terminal, as shown in FIG. 1c. The receiving terminal 120 may include a signal receiving unit 122 and a POS unit 124 that performs a conventional POS function. When the payment terminal 110 is a photonic payment terminal, the signal receiving unit 122 of the receiving terminal 120 is a light receiving unit accordingly. In this case, the receiving terminal 120 may also be called a photonic receive end.

The receiving terminal 120-n may communicate with the payment terminal 110 by using the signal receiving unit 122. The payment terminal 110 may include an encoding unit 112. Generally, the encoding unit 112 may encode to-be-transmitted communication data. The communication data may be any information data that needs to be transmitted by the payment terminal 110 to the receiving terminal 120-n, for example, identity information. When the payment terminal 110 is a photonic payment terminal and the receiving terminal 120 is a photonic receive end, the encoding unit 112 may encode the to-be-transmitted communication data such as the photonic identity information. Commonly known encoding may include RZ pulse count encoding. The RZ pulse count encoding is to put n bits of original information into a group, an inter-group time interval is set between two adjacent groups of signals, and a quantity of pulses in each group denotes information of n bits in this group of signals. For example, when n=2, that is, two bits combine into one group, 1, 2, 3, and 4 pulses are used to represent 00, 01, 10, and 11 respectively. Commonly known encoding may further include PPM encoding.

Preferably, the payment terminal 110 may further include an encryption unit 114. The encryption unit 114 may encrypt the communication data first, and then the encoding unit 112 performs the encoding on the encrypted communication data.

After the communication data is encoded, the signal transmitting unit 116 may send the communication data, for example, in the form of a transmitted signal. When the signal transmitting unit 116 is a light emitting unit, the light emitting unit 116 may send the received encoded signal in the form of visible light by using light to represent a high-level signal and using absence of light to represent a low level.

The signal receiving unit 122 of the receiving terminal 120-n may be configured to receive and process the transmitted signal that is transmitted by the signal transmitting unit 116 so as to obtain, for example, communication data in the form of an electric signal. In an instance, the signal receiving unit 122 may convert, amplify, filter, and in other ways process the received transmitted signal. When the payment terminal 110 is a photonic payment terminal and the receiving terminal 120 is a photonic receive end, the light receiving unit 122 of the photonic receive end 120-n may be configured to receive a visible light signal transmitted by the light emitting unit 116, and convert the visible light signal into an electric signal so as to obtain, for example, communication data in the form of an electric signal. For example, for frequent flashing generated by an LED lamp, light may represent a high level and absence of light may represent a low level, or absence of light may represent a high level and light may represent a low level. In this way, the received visible light signal can be converted into a digital signal. The light receiving unit 122 may include a light sensitive device such as a photodiode and a phototriode. An electric pulse signal is generated by using characteristics of the electric signal and the light signal of the light sensitive device and by means of optical-to-electric conversion. In practice, relative locations of the photonic payment terminal 110 to the photonic receive end 120-n are different. That is, light signal intensity transmitted by each photonic payment terminal 110 to the photonic receive end 120-n is different. Therefore, the electric signal strength is different, and current generated by the photodiode needs to be rectified and compared. For example, when the current value that passes through the diode is higher than a specific threshold, an optical-to-electric conversion circuit adjusts an output voltage level value to a high level; and when the current value that passes through the photodiode is lower than a specific threshold, the optical-to-electric conversion circuit adjusts the output voltage level value to a low level. The threshold is set according to different environments by using a mathematic model. For example, when a communication distance is long, the threshold may be lower; and when the communication distance is short, the threshold may be higher. In this way, the level can be adjusted into a specific range to ensure a correct pulse shape and maximally ensure sampling accuracy.

When the user needs to pay for consumption at a merchant, the user may use the payment terminal 110 to send the identity information to the receiving terminal 120-n in the form of a transmitted signal such as a light signal, where the identity information may include, for example, an identity ID and a payment password. Specifically, the encoding unit 112 may encode the identity information. Preferably, the encryption unit 114 may encrypt the identity information first, and then the encoding unit 112 encodes the encrypted identity information. The signal transmitting unit 116 may send a transmitted signal that indicates the encoded identity information.

When the user binds the identity information to multiple payment accounts and no default payment account is set for payment, the user may select, from the bound multiple payment accounts, a payment account used for payment. In this case, the identity information may carry an identifier that indicates a payment account selected for payment. For example, the identifier may indicate a serial number of the payment account when the payment account is bound.

The user may use payment software on the payment terminal 110 to start sending of the identity information, selection of the payment account, and the like. Before the payment function is started, the user may input a payment password. Preferably, the payment software performs a payment operation after successfully performing a preliminary authentication on the payment password.

The signal receiving unit 122 of the receiving terminal 120-n may receive and process the transmitted signal that is transmitted by the payment terminal 110, so as to obtain identity information in the form of an electric signal. In an instance, the receiving terminal 120-n may include a decoding unit for decoding the electric signal and restoring the identity information. In another preferred embodiment, the receiving terminal 120-n does not decode the electric signal, but the POS unit 124 directly retransmits the encoded identity information in the form of an electric signal. In an instance, the user may input account authentication information of the payment account according to requirements after the identity information is sent by using the payment terminal 110. The account authentication information of the payment account is authenticated by an issuing institution (such as the payment transaction system) of the payment account in a subsequent payment process. The receiving terminal 120-n may include an input unit 126, for example, a keyboard, a handwriting pad, a fingerprint recognition module, an iris recognition module, and a sound recognition module. The user may input the account authentication information such as a password, a signature, a fingerprint, an iris, a sound, or a signature panel by using the input unit 126.

After receiving the identity information, the receiving terminal 120-n may upload transaction information to the corresponding acquiring platform 130-n. The transaction information may include the identity information. In an instance in which the user needs to input the account authentication information of the payment account, the transaction information may further include the account authentication information. In addition, the receiving terminal 110 is generally bound to a merchant account, and therefore, the transaction information may further include information such as a merchant ID and a payment amount.

The acquiring platform 130-n may be configured to implement interaction between the receiving terminal 120-n, the user management platform 140, and the settlement platform 150. The receiving terminal 120-n may upload the transaction information to the acquiring platform 130-n by using a dedicated line. After receiving the transaction information, the acquiring platform 130-n may obtain, based on the identity information, payment account information of a payment account used for payment. Then the acquiring platform 130-n may send a payment request, where the payment request may include the payment account information of the payment account used for payment.

In an instance, the acquiring platform 130-n may retransmit the identity information to the user management platform 140, and the user management platform 140 authenticates the identity information. The user management platform 140 may include an authentication unit 142 for performing the authentication. For example, the account of the user of the payment terminal 110 and the correlated identity information (for example, the identity ID and the payment password) are stored in a database 143 of the user management platform 140. In an instance in which the identity information includes the identity ID, the authentication unit 142 may retrieve, from the database 143, the identity ID received from the acquiring platform 130-n; and if the identity ID is not retrieved successfully, the identity information is illegal, and the authentication fails; or, if the identity ID is retrieved successfully, the authentication succeeds.

In an instance in which the identity information further includes a payment password, if the identity ID is retrieved successfully, the payment password correlated with the identity ID is further obtained, and the payment password is compared with the payment password received from the acquiring platform 130-n. If the two passwords are same, the authentication succeeds; otherwise, the authentication fails.

In an instance, the identity information received by the user management platform 140 is encrypted and encoded. In this instance, the user management platform 140 may include a decoding unit 144 and a decryption unit 145. The decoding unit 144 may decode the identity information first, and then the decryption unit 145 performs decryption to restore the identity information.

In response to successful authentication, the user management platform 140 may retrieve, from the database 143, the payment account information of the payment account that is correlated with the identity information and used for payment, and send the payment account information of the payment account to the acquiring platform 130-n. The user management platform 140 may be correlated with multiple financial institutions, so as to store payment account information of payment accounts issued by the multiple financial institutions. In an instance, the user sets a default payment account. In this case, the user management platform 140 may directly retrieve, in response to successful authentication, the payment account information of the payment account that is correlated with the identity information and used for payment by default. In another example, the user does not set a default payment account, but selects, when paying, a payment account used for payment, as mentioned above. In this case, the user identity information may carry an identifier that indicates a payment account used for payment. For example, the identifier may indicate a serial number of the payment account when the payment account is bound. According to the identifier, the user management platform 140 may retrieve the payment account information of the payment account used for payment. The user management platform 140 may send the retrieved payment account information of the payment account to the acquiring platform 130-n.

In an alternative embodiment, the payment account information of the payment account may be stored in the acquiring platform 130-n. In this embodiment, the user management platform 140 does not store the payment account information as mentioned above, but stores account correlation information that can be used to obtain the payment account information, for example, account index information. In this case, information sent by the user management platform 140 to the acquiring platform 130-n may be only the account correlation information used to obtain the payment account information. The acquiring platform 130-n may find the payment account information of the payment account in a database of the acquiring platform according to the account correlation information.

In another aspect, in response to an authentication failure, the user management platform 140 may send an authentication failure message to the acquiring platform 130-n.

The acquiring platform 130-n may upload a payment request in response to the obtained payment account information of the payment account. The acquiring platform 130-n may send the payment request to the settlement platform 150. The payment request may include payment account information, a payment amount, and a merchant ID. When the user inputs the account authentication information on the receiving terminal 120-n, the payment request may further include the account authentication information. Conversely, if an authentication failure message is received, the acquiring platform 130-n may retransmit the authentication failure message to the receiving terminal 120-n to notify the merchant and the user of the payment failure.

The settlement platform 150 may perform settlement in response to the payment request received from the acquiring platform 130-n. In an instance, the settlement platform 150 may submit a settlement request to a corresponding payment transaction system 160-n according to the payment account information. The settlement request may include the payment account information and the payment amount. When the user inputs the account authentication information on the receiving terminal 120-n, the settlement request may further include the account authentication information. The payment transaction system 160-n is a transaction system corresponding to the payment account used for payment. For example, if the payment account is a bank card issued by a bank, the payment transaction system is a bank payment transaction system of the bank accordingly. According to different payment accounts, the settlement platform 150 may send a settlement request to different payment transaction systems.

The settlement platform 150 herein is a public settlement platform, and is separated from each payment transaction server 160-n. However, the settlement platform 150 may also be multiple settlement platforms correlated with different financial institutions. In this case, each settlement platform may be integrated into a correlated payment transaction server.

The payment transaction server 160-n may perform a payment transaction based on the settlement request from the settlement platform 150 and the confirmation information from the payment terminal 110.

In this instance, the confirmation information may include a payment transaction password of the payment account. If the payment transaction password is correct, the payment transaction server 160-n performs the payment transaction; otherwise, the payment transaction server feeds back a failure notification message to the settlement platform 150 and the payment terminal 110.

In an instance, the payment transaction server 160-n sends a confirmation request to the payment terminal 110, and the payment terminal 110 may send confirmation information to the payment transaction server 160-n in response to the confirmation request.

After verifying the payment account information, for example, after the payment account information is confirmed by the confirmation information, the payment transaction system 160-n may deduct the payment amount from a corresponding payment account. In an instance in which the settlement request includes the account authentication information, the payment transaction system 160-n may verify legality of the payment account information by using the account authentication information. It is noted that the payment transaction system 160-n does not directly disburse the deducted payment amount into a merchant account, but disburses the payment amount into a transaction account opened at the bank for the settlement platform 150. The settlement platform 150 performs settlement with the merchant periodically. Therefore, payment is deemed successful once the settlement platform 150 receives the payment amount transferred by the payment transaction system 160-n. After the transfer, the payment transaction system 160-n may feed back the payment settlement information such as a payment account number and a deducted amount to the settlement platform 150.

The settlement platform 150 may retransmit the payment settlement information to the acquiring platform 130-n, and the acquiring platform 130-n further sends the payment settlement information to the user management platform 140 and the receiving terminal 120-n. The user management platform 140 may feed back the payment settlement information to the payment terminal 110. In addition, the receiving terminal 120-n may print the payment settlement information.

In this way, the user can complete transaction payment by using the payment terminal 110.

FIG. 2 shows a payment system 200 according to a second embodiment of the present disclosure. The payment system 200 is similar to the payment system 100, but differs in that a user management platform 240-n (n=1, 2, . . . N) replaces the public user management platform 140. That is, each acquiring platform 230-n has a user management platform 240-n that is communicationally coupled with only the acquiring platform. As mentioned above, the receiving terminal 220-n may be correlated with a financial institution, and different receiving terminals are affiliated to different financial institutions. Accordingly, the acquiring platform 230-n may also be correlated with a financial institution, and different acquiring platforms are affiliated to different financial institutions. In addition, the payment transaction system 260-n is correlated with a financial institution, and different payment transaction systems are affiliated to different financial institutions.

Therefore, in this embodiment, there are different user management platforms corresponding to different financial institutions. That is, each user management platform 240-n is correlated with a different financial institution. Account information of a payment account issued by a financial institution correlated with each user management platform 240-n may be stored in this user management platform. For example, the receiving terminal 220-1 and the acquiring platform 230-1 are correlated with a first financial institution, for example, affiliated to the first financial institution. The corresponding user management platform 240-1 is also correlated with the first financial institution. In this case, payment account information of a payment account issued by the first financial institution may be stored in the user management platform 240-1. Similarly, the receiving terminal 220-2, the acquiring platform 230-2, and the user management platform 240-2 may be correlated with a second financial institution. In this case, payment account information of a payment account issued by the second financial institution may be stored in the user management platform 240-2.

When a user pays a merchant, if the receiving terminal of the merchant is the 220-1, the receiving terminal 220-1 is a receiving terminal of the first financial institution. In a payment system architecture in this embodiment, in a case of intra-institution payment, the acquiring platform 230-1 can obtain the payment account information of the payment account from the user management platform 240-1. For example, the acquiring platform 230-1 sends the identity information to the user management platform 240-1 in response to a judgment that the payment account is a payment account issued by the first financial institution, and obtains the payment account information of the payment account accordingly. In an instance, the judgment may be made by the receiving terminal 220-1 or the acquiring platform 230-1 according to financial institution identification information that is sent together with the identity information from the payment terminal 210.

According to the solution of the present disclosure, the user does not need to carry numerous payment accounts, and can implement payment by using a mobile phone that has a signal transmission function such as an acoustic transmission function. In contrast with an online payment method, security of the payment is ensured because a secure POS end is used as an interface to enter the payment transaction system in a payment process according to the solution of the present disclosure. In addition, in a conventional offline payment by swiping a card, magnetic track information of a payment account is vulnerable to theft. However, according to the solution in the present disclosure, the POS end does not transmit the account information of the payment account, so that security is improved significantly.

The solution in the present disclosure is applicable to payment with a payment account issued by any financial institution such as a bank or a third-party payment institution. When the payment account is a payment account issued by a third-party payment institution, the solution of the present disclosure is especially applicable to a payment process in which a balance is available in the payment account, but the solution of the present disclosure is not limited thereto.

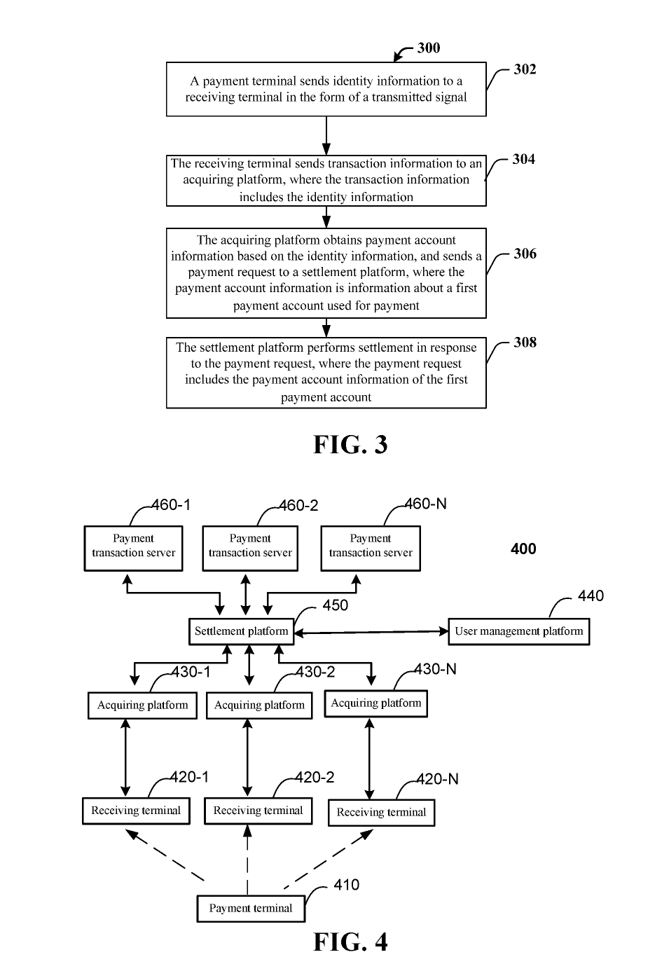

FIG. 3 is a flowchart of a payment method 300 according to one aspect of the present disclosure.

In step 302, a payment terminal sends identity information to a receiving terminal in the form of a transmitted signal.

In an instance, the payment terminal may encode the identity information, and send the encoded identity information to the receiving terminal in the form of a transmitted signal such as a light signal. Preferably, the payment terminal may encrypt the identity information first, and then encode the encrypted identity information. The receiving terminal receives and processes the transmitted signal to obtain an electric signal. For example, when the transmitted signal is a light signal, a photoelectric conversion may be performed to obtain identity information in the form of an electric signal.

In an instance, the identity information may include an identity ID. Preferably, the identity information may further include a payment password.

In step 304, the receiving terminal sends transaction information to an acquiring platform, where the transaction information may include the identity information.

In step 306, the acquiring platform may obtain payment account information based on the identity information, and send a payment request to a settlement platform, where the payment account information is information about a payment account used for payment, for example, a first payment account.

In an instance, the acquiring platform may retransmit the identity information to the user management platform, and the user management platform may authenticate the received identity information. In an instance, the identity information includes an identity ID. The user management platform may retrieve the received identity ID from the database of the user management platform. If the identity ID is not retrieved successfully, the identity information is illegal, and the authentication fails. If the identity ID is retrieved successfully, the authentication succeeds. Preferably, when the identity ID is retrieved successfully, the user management platform may further obtain a payment password correlated with the identity ID, and compare the payment password with the received payment password. If the two passwords are same, the authentication succeeds; otherwise, the authentication fails.

In an instance, the identity information received by the user management platform is encrypted and encoded. In this instance, the user management platform may decode the identity information first, and then perform decryption to restore the identity information.

In response to successful authentication, the user management platform may send the payment account information of the first payment account to the acquiring platform. In an alternative embodiment, the user management platform may send account correlation information of the payment account information, where the account correlation information is available to the acquiring platform for finding the payment account information. In an instance, the first payment account is a default payment account. In this case, the user management platform may directly retrieve, in response to successful authentication, the payment account information of the first payment account that is correlated with the identity information and used for payment by default. In another instance, no default payment account is set by the user. In this case, the identity information may carry an identifier that indicates the first payment account. According to the identifier, the user management platform may retrieve the payment account information of the first payment account correlated with the identity information. In response to the received payment account information, the acquiring platform may send a payment request to the settlement platform, where the payment request may include the payment account information. In addition, the payment request may further include a merchant ID and a payment amount.

In response to an authentication failure, the user management platform may send an authentication failure message to the acquiring platform. The acquiring platform may retransmit the authentication failure message to the receiving terminal in response to the received authentication failure message.

In an instance, the acquiring platform and the user management platform are correlated with the first financial institution, and payment account information of a payment account issued by the first financial institution is stored in the user management platform. In this case, the acquiring platform sends the identity information to the user management platform in response to a judgment that the first payment account is a payment account issued by the first financial institution.

In step 308, the settlement platform performs settlement in response to the payment request, where the payment request includes the payment account information of the first payment account.

In an instance, the settlement platform may send a settlement request to a payment transaction server corresponding to the first payment account in response to the payment request, where the settlement request may include the payment account information of the first payment account. The settlement request may further include a payment amount.

The payment transaction system may disburse the payment amount into a transaction account of the settlement platform, and feed back payment settlement information to the settlement platform. The settlement platform may retransmit the payment settlement information to the acquiring platform in response to the received payment settlement information, and the acquiring platform sends the received payment settlement information to the user management platform and the receiving terminal. Further, the user management platform may feed back the payment settlement information to the payment terminal.

In another instance, the settlement platform may send a settlement request to a payment transaction server corresponding to the first payment account in response to the payment request. The payment transaction server may perform a payment transaction based on the settlement request from the settlement platform and the confirmation information from the payment terminal, where the settlement request may include the payment account information of the first payment account.

For example, the confirmation information may include a payment transaction password of the first payment account. If the payment transaction password is correct, the payment transaction server performs the payment transaction; otherwise, the payment transaction server feeds back a failure notification message to the settlement platform and the payment terminal.

For example, the payment transaction server sends a confirmation request to the payment terminal, and the payment terminal may send confirmation information to the payment transaction server in response to the confirmation request.

After the confirmation, the payment transaction server may disburse the payment amount into a transaction account of the settlement platform, and feed back payment settlement information to the settlement platform. The settlement platform may retransmit the payment settlement information to the acquiring platform in response to the received payment settlement information, and the acquiring platform sends the received payment settlement information to the receiving terminal.

FIG. 4 is a block diagram of a payment system 400 according to a third embodiment of the present disclosure. The payment system 400 differs from the payment system 100 in that the user management platform 440 can be communicationally coupled with the settlement platform 450.

In this instance, when the user needs to pay for consumption at a merchant, the user may use the payment terminal 410 to send the identity information to the receiving terminal 420-n in the form of a transmitted signal such as a light signal, where the identity information may include an identity ID and a payment password, for example. Specifically, the encoding unit 112 may encode the identity information. Preferably, the encryption unit 114 may encrypt the identity information first, and then the encoding unit 112 encodes the encrypted identity information. The signal transmitting unit 116 may send a transmitted signal that indicates the encoded identity information.

When the user binds the identity information to multiple payment accounts and no default payment account is set for payment, the user may select, from the bound multiple payment accounts, a payment account used for payment. In this case, the identity information may carry an identifier that indicates a payment account selected for payment. For example, the identifier may indicate a serial number of the payment account when the payment account is bound.

The user may use payment software on the payment terminal 410 to start sending of the identity information, selection of the payment account, and the like. Before the payment function is started, the user may input a payment password. Preferably, the payment software performs a payment operation after successfully performing a preliminary authentication on the payment password.

The signal receiving unit 122 of the receiving terminal 420-n may receive and process the transmitted signal that is transmitted by the payment terminal 410, so as to obtain identity information in the form of an electric signal. In an instance, the receiving terminal 420-n may include a decoding unit for decoding the electric signal and restoring the identity information. In another preferred embodiment, the receiving terminal 420-n does not decode the electric signal, but the POS unit 124 directly retransmits the encoded identity information in the form of an electric signal. In an instance, the user may input account authentication information of the payment account according to requirements after the identity information is sent by using the payment terminal 410. The account authentication information of the payment account is authenticated by an issuing institution (such as the payment transaction system) of the payment account in a subsequent payment process. The receiving terminal 420-n may include an input unit 126, for example, a keyboard, a handwriting pad, a fingerprint recognition module, an iris recognition module, and a sound recognition module. The user may input the account authentication information such as a password, a signature, a fingerprint, an iris, or a sound by using the input unit 126.

After receiving the identity information, the receiving terminal 420-n may upload transaction information to the corresponding acquiring platform 430-n. The transaction information may include the identity information. In an instance in which the user needs to input the account authentication information of the payment account, the transaction information may further include the account authentication information. In addition, the receiving terminal 410 is generally bound to a merchant account, and therefore, the transaction information may further include information such as a merchant ID and a payment amount.

The acquiring platform 430-n can implement interaction between the receiving terminal 420-n and the settlement platform 450. The receiving terminal 420-n may upload the transaction information to the acquiring platform 430-n by using a dedicated line. The acquiring platform 430-n may upload the identity information. For example, the acquiring platform 430-n may send a payment request, where the payment request may include the identity information. The payment request may further include a payment amount and a merchant ID. When the user inputs the account authentication information on the receiving terminal 420-n, the payment request may further include the account authentication information.

The settlement platform 450 may receive the payment request, so as to obtain payment account information based on the identity information from the acquiring platform 430-n, where the payment account information is information about a payment account used for payment.

In an instance, the settlement platform 450 may retransmit the identity information to the user management platform 440, and the user management platform 440 authenticates the identity information. The user management platform 440 may include an authentication unit 142 for performing the authentication. For example, the account of the user of the payment terminal 410 and the correlated identity information (for example, the identity ID and the payment password) are stored in a database 143 of the user management platform 440. In an instance in which the identity information includes the identity ID, the authentication unit 142 may retrieve, from the database 143, the identity ID received from the settlement platform 450. If the identity ID is not retrieved successfully, the identity information is illegal, and the authentication fails; or, if the identity ID is retrieved successfully, the authentication succeeds.

In an instance in which the identity information further includes a payment password, if the identity ID is retrieved successfully, the payment password correlated with the identity ID is further obtained, and the payment password is compared with the payment password received from the settlement platform 450. If the two passwords are same, the authentication succeeds; otherwise, the authentication fails.

In an instance, the identity information received by the user management platform 440 is encrypted and encoded. In this instance, the user management platform 440 may include a decoding unit 144 and a decryption unit 145. The decoding unit 144 may decode the identity information first, and then the decryption unit 145 performs decryption to restore the identity information.

In response to successful authentication, the user management platform 440 may retrieve, from the database 143, the payment account information of the payment account that is correlated with the identity information and used for payment, and send the payment account information of the payment account to the settlement platform 450. The user management platform 440 may be correlated with multiple financial institutions, so as to store payment account information of payment accounts issued by the multiple financial institutions. In an instance, the user sets a default payment account. In this case, the user management platform 440 may directly retrieve, in response to successful authentication, the payment account information of the payment account that is correlated with the identity information and used for payment by default. In another example, the user does not set a default payment account, but selects, when paying, a payment account used for payment, as mentioned above. In this case, the user identity information may carry an identifier that indicates a payment account used for payment. For example, the identifier may indicate a serial number of the payment account when the payment account is bound. According to the identifier, the user management platform 440 may retrieve the payment account information of the payment account used for payment. The user management platform 440 may send the retrieved payment account information of the payment account to the settlement platform 450.

In an alternative embodiment, the payment account information of the payment account may be stored in the settlement platform 450. In this embodiment, the user management platform 440 does not store the payment account information as mentioned above, but stores account correlation information that can be used to obtain the payment account information, for example, account index information. In this case, information sent by the user management platform 440 to the settlement platform 450 may be only the account correlation information used to obtain the payment account information. The settlement platform 450 may find the payment account information of the payment account in a database of the settlement platform according to the account correlation information.

In another aspect, in response to an authentication failure, the user management platform 440 may send an authentication failure message to the settlement platform 450. If an authentication failure message is received, the settlement platform 450 may retransmit the authentication failure message to acquiring platform 430-n, and the acquiring platform feeds back the authentication failure message to the receiving terminal 420-n to notify the merchant and the user of the payment failure.

The settlement platform 450 may perform settlement in response to the obtained payment account information of the payment account. In an instance, the settlement platform 450 may submit a settlement request to a corresponding payment transaction system 460-n according to the payment account information. The settlement request may include the payment account information and the payment amount. When the user inputs the account authentication information on the receiving terminal 420-n, the settlement request may further include the account authentication information. The payment transaction system 460-n is a transaction system corresponding to the payment account used for payment. For example, if the payment account is a bank card issued by a bank, the payment transaction system is a bank payment transaction system of the bank accordingly. According to different payment accounts, the settlement platform 450 may send a settlement request to different payment transaction systems.

After verifying the payment account information, the payment transaction system 460-n may deduct the payment amount from a corresponding payment account. In an instance in which the settlement request includes the account authentication information, the payment transaction system 460-n may verify legality of the payment account information by using the account authentication information. It is noted that the payment transaction system 460-n does not directly disburse the deducted payment amount into a merchant account, but disburses the payment amount into a transaction account opened at the bank for the settlement platform 450. The settlement platform 450 performs settlement with the merchant periodically. Therefore, payment is deemed successful once the settlement platform 450 receives the payment amount transferred by the payment transaction system 460-n. After the transfer, the payment transaction system 460-n may feed back the payment settlement information such as a payment account number and a deducted amount to the settlement platform 450.

The settlement platform 450 may retransmit the payment settlement information to the acquiring platform 430-n, and the acquiring platform 430-n further sends the payment settlement information to the user management platform 440 and the receiving terminal 420-n. The user management platform 440 may feed back the payment settlement information to the payment terminal 410. In addition, the receiving terminal 420-n may print the payment settlement information.

In this way, the user can complete transaction payment by using the payment terminal 410.

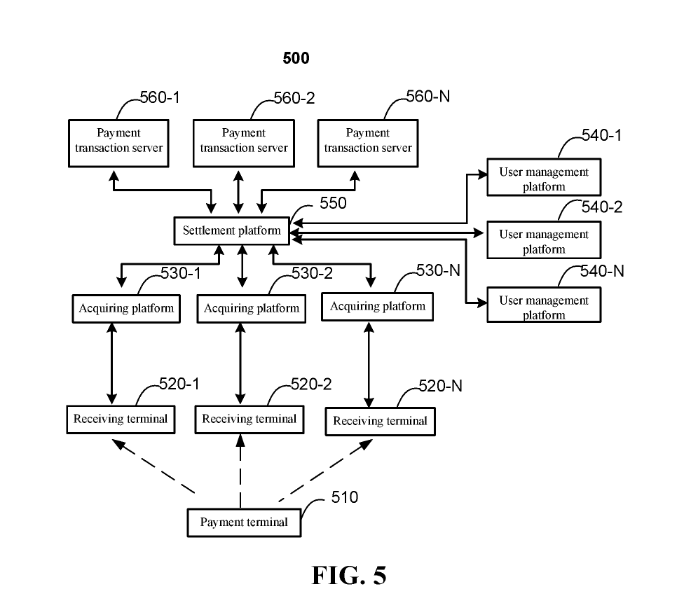

FIG. 5 is a block diagram of a payment system 500 according to a fourth embodiment of the present disclosure. The payment system 500 is similar to the payment system 400, but differs in that the user management platform 540-n (n=1, 2, . . . N) replaces the public user management platform 540. As mentioned above, the receiving terminal 520-n may be correlated with a financial institution, and different receiving terminals are affiliated to different financial institutions. Accordingly, the acquiring platform 530-n may also be correlated with a financial institution, and different acquiring platforms are affiliated to different financial institutions. In addition, the payment transaction system 560-n is correlated with a financial institution, and different payment transaction systems are affiliated to different financial institutions.

In this embodiment, there are different user management platforms corresponding to different financial institutions. That is, each user management platform 540-n is correlated with a different financial institution. Account information of a payment account issued by a financial institution correlated with each user management platform 540-n may be stored in this user management platform. For example, the receiving terminal 520-1 and the acquiring platform 530-1 are correlated with a first financial institution, for example, affiliated to the first financial institution. The corresponding user management platform 540-1 is also correlated with the first financial institution. In this case, payment account information of a payment account issued by the first financial institution may be stored in the user management platform 540-1. Similarly, the receiving terminal 520-2, the acquiring platform 530-2, and the user management platform 540-2 may be correlated with a second financial institution. In this case, payment account information of a payment account issued by the second financial institution may be stored in the user management platform 540-2.

In an architecture of this instance, when the settlement platform 550 obtains the payment account information of the payment account, the user management platform 440-n to which the identity information is retransmitted may be a user management platform correlated with a financial institution that issues the payment account. The payment account information of the payment account issued by the financial institution or account correlation information is stored in the user management platform.

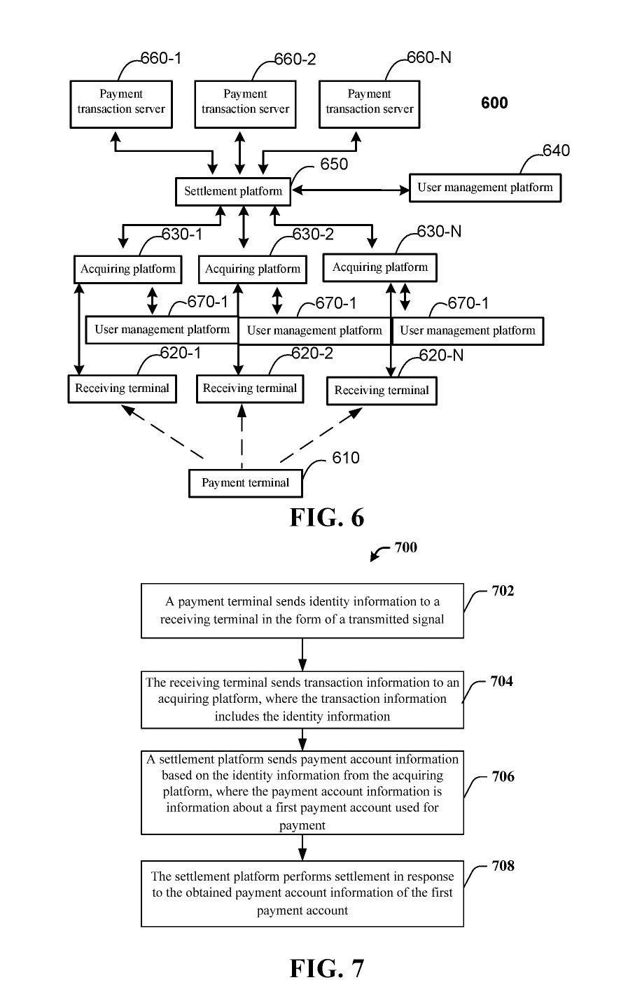

FIG. 6 is a block diagram of a payment system 600 according to a fifth embodiment of the present disclosure. The payment system 600 is similar to the payment system 400, but differs in that, in addition to the user management platform 640, each acquiring platform 230-n has a user management platform 670-n that is communicationally coupled with only the acquiring platform. As mentioned above, the receiving terminal 220-n may be correlated with a financial institution, and different receiving terminals are affiliated to different financial institutions. Accordingly, the acquiring platform 230-n may also be correlated with a financial institution, and different acquiring platforms are affiliated to different financial institutions. In addition, the payment transaction system 260-n is correlated with a financial institution, and different payment transaction systems are affiliated to different financial institutions.

Therefore, in this embodiment, there are different user management platforms 670-n corresponding to different financial institutions. That is, each user management platform 670-n is correlated with a different financial institution. Account information of a payment account issued by a financial institution correlated with each user management platform 670-n may be stored in this user management platform. For example, the receiving terminal 620-1 and the acquiring platform 630-1 are correlated with a first financial institution, for example, affiliated to the first financial institution. The corresponding user management platform 670-1 is also correlated with the first financial institution. In this case, payment account information of a payment account issued by the first financial institution may be stored in the user management platform 670-1. Similarly, the receiving terminal 620-2, the acquiring platform 630-2, and the user management platform 670-2 may be correlated with a second financial institution. In this case, payment account information of a payment account issued by the second financial institution may be stored in the user management platform 670-2. Different from the user management platform 670-n, the user management platform 640 may be correlated with multiple financial institutions, so as to store payment account information of payment accounts issued by the multiple financial institutions.

When a user pays a merchant, if the receiving terminal of the merchant is the 620-2, the receiving terminal 620-2 is a receiving terminal of the second financial institution. The payment account selected by the user for payment may be a payment account issued by the second financial institution (that is, intra-institution payment), or may be not a payment account issued by the second financial institution (that is, inter-institution payment).

In a payment system architecture in this embodiment, in a case of inter-institution payment, for example, at the receiving terminal 620-2, if the payment account selected by the user is the first payment account issued by the first financial institution, the acquiring platform 630-2 may send the identity information to the settlement platform 650, and the settlement platform obtains the payment account information of the first payment account from the public user management platform 640. For example, the acquiring platform 630-2 may send a payment request to the settlement platform 650 in response to a judgment that the payment account is not a payment account issued by the first financial institution, where the payment request may include the identity information. In an instance, the judgment may be made by the receiving terminal 620-2 or the acquiring platform 630-2 according to financial institution identification information that is sent together with the identity information from the payment terminal 610.

FIG. 7 is a flowchart of a payment method 700 according to another aspect of the present disclosure.

In step 702, a payment terminal sends identity information to a receiving terminal in the form of a transmitted signal.

In an instance, the payment terminal may encode the identity information, and send the encoded identity information to the receiving terminal in the form of a transmitted signal such as a light signal. Preferably, the payment terminal may encrypt the identity information first, and then encode the encrypted identity information. The receiving terminal receives and processes the transmitted signal to obtain an electric signal, so as to obtain identity information in the form of an electric signal.

In an instance, the identity information may include an identity ID. Preferably, the identity information may further include a payment password.

In step 704, the receiving terminal sends transaction information to an acquiring platform, where the transaction information may include the identity information. The acquiring platform may send a payment request to the settlement platform after receiving the transaction information, where the payment request may include the identity information. In addition, the payment request may further include a merchant ID and a payment amount.

In step 706, the settlement platform obtains the payment account information based on the identity information from the acquiring platform, where the payment account information is information about a payment account used for payment, for example, the first payment account.

In an instance, the settlement platform may retransmit the identity information to the first user management platform, and the first user management platform may authenticate the received identity information. In an instance, the identity information includes an identity ID. The first user management platform may retrieve the received identity ID from the database of the user management platform. If the identity ID is not retrieved successfully, the identity information is illegal, and the authentication fails. If the identity ID is retrieved successfully, the authentication succeeds. Preferably, when the identity ID is retrieved successfully, the first user management platform may further obtain a payment password correlated with the identity ID, and compare the payment password with the received payment password. If the two passwords are same, the authentication succeeds; otherwise, the authentication fails.

In an instance, the identity information received by the first user management platform is encrypted and encoded. In this instance, the first user management platform may decode the identity information first, and then perform decryption to restore the identity information.

In response to successful authentication, the first user management platform may send the payment account information of the first payment account to the settlement platform. In an alternative embodiment, the user management platform may send account correlation information of the payment account information, where the account correlation information is available to the settlement platform for finding the payment account information. In an instance, the first payment account is a default payment account. In this case, the first user management platform may directly retrieve, in response to successful authentication, the payment account information of the first payment account that is correlated with the identity information and used for payment by default. In another instance, no default payment account is set by the user. In this case, the identity information may carry an identifier that indicates the first payment account. According to the identifier, the first user management platform may retrieve the payment account information of the first payment account correlated with the identity information.

In response to an authentication failure, the first user management platform may send an authentication failure message to the settlement platform. The settlement platform may retransmit the authentication failure message to the acquiring platform in response to the received authentication failure message, and the acquiring platform feeds back the authentication failure message to the receiving terminal.

In an instance, the first user management platform may be correlated with a first financial institution that issues the first payment account, and payment account information of a payment account issued by the first financial institution is stored in the first user management platform.

In another instance, the first user management platform is correlated with multiple financial institutions including the first financial institution that issues the first payment account, and payment account information of payment accounts issued by the multiple financial institutions is stored in the first user management platform.

In another instance, the acquiring platform is communicationally coupled with a second user management platform. The acquiring platform and the second user management platform are correlated with the second financial institution. Payment account information of a payment account issued by the second financial institution is stored in the second user management platform. In this instance, the acquiring platform may send a payment request to the settlement platform in response to a judgment that the first payment account is not a payment account issued by the second financial institution, where the payment request may include the identity information.

In step 708, the settlement platform performs settlement in response to the obtained payment account information of the first payment account.

In an instance, the settlement platform may send a settlement request to a payment transaction system corresponding to the first payment account, where the settlement request may include the payment account information of the first payment account. The settlement request may further include a payment amount.

The payment transaction system may disburse the payment amount into a transaction account of the settlement platform, and feed back payment settlement information to the settlement platform. The settlement platform may retransmit the payment settlement information to the acquiring platform in response to the received payment settlement information, and the acquiring platform sends the received payment settlement information to the receiving terminal.

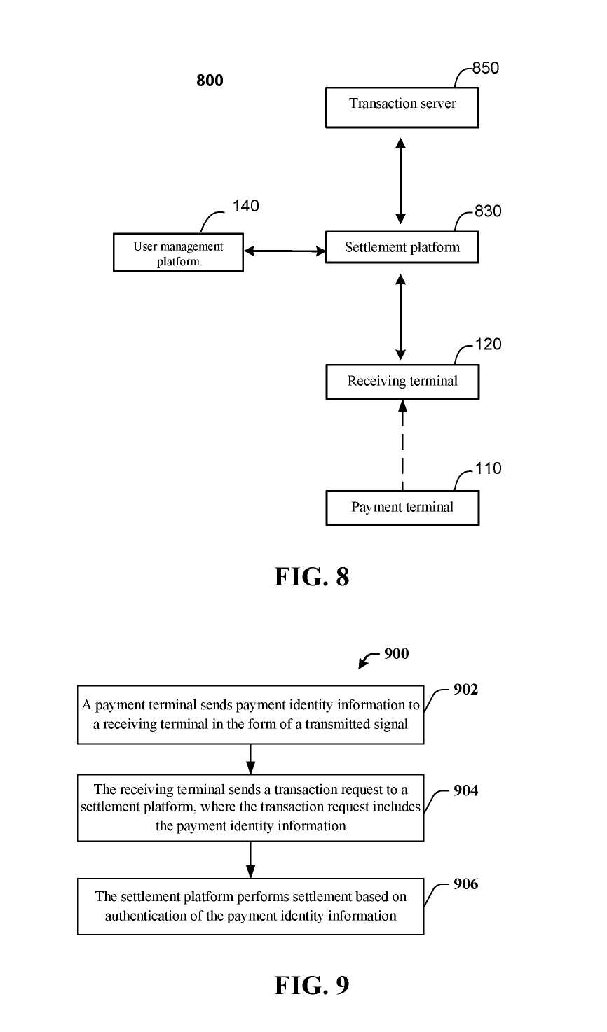

FIG. 8 is a block diagram of a payment system according to a sixth embodiment of the present disclosure. The payment system 800 may include a payment terminal 110. As shown in FIG. 1a, the payment terminal 110 may be any appropriate portable terminal that includes a signal transmitting unit 116, for example, a cellular phone, a satellite phone, a cordless phone, a personal digital assistant (PDA), a handheld device with a wireless connection capability, a computing device, or other processing devices connected to a wireless modem or the like. The payment terminal 110 may use the signal transmitting unit 116 to communicate with other devices with a signal receiving capability. For example, the signal transmitting unit 116 may be a light emitting unit, an acoustic unit, an infrared unit, a WiFi unit, or a radio frequency unit. When the transmitting unit 116 is a light emitting unit, the payment terminal 110 may be called a photonic payment terminal, so that light communication between the payment terminal and other devices with a light communication capability can be performed by using the light emitting unit 116. For example, light represents a high level, and absence of light represents a low level. Therefore, the light emitting unit 116 may use a light emitting diode (LED), for example, to emit light regularly in a frequently flashing manner to denote significant signals.

The payment system 800 may include a user management platform 140 to implement user information management. The payment terminal 110 may access the user management platform 140 by using a wireless communications system. The wireless communications system may be CDMA, TDMA, FDMA, OFDMA, SC-FDMA, or other systems. A CDMA system can implement radio technologies such as universal terrestrial radio access (UTRA) and cdma2000. The UTRA includes wideband CDMA (W-CDMA) and other CDMA variants. In addition, the cdma2000 covers IS-2000, IS-95, and IS-856 standards. The TDMA system can implement radio technologies such as Global System for Mobile communications (GSM). An OFDMA system can implement radio technologies such as evolved UTRA (E-UTRA), ultra mobile broadband (UMB), IEEE 802.11 (Wi-Fi), IEEE 802.16 (WiMAX), IEEE 802.20, and Flash-OFDM®.

A user may request to get registered on the user management platform 140 by using the payment terminal 110. As shown in FIG. 1d, the user management platform 140 may include a registration unit 141 for registering an account. In response to a registration request from the payment terminal 110, the registration unit 141 may register an account for the payment terminal 110, and allocate payment identity information to the account. For example, the payment identity information may include a payment ID. The payment ID may be stored in the user management platform 140, for example, stored in a database 143 of the user management platform 140. When the payment terminal 110 is a photonic payment terminal, the account may be called a light account, and the identity information may be called photonic identity information. Accordingly, the identity ID may be called a light ID.

After the account is registered, the user may set a corresponding login password, and may use the payment terminal 110 to log in to the account. If the user forgets the login password, the original login password may be regained by using short message authentication, email authentication, or identity correlation information authentication or the like, which is well-known by a person skilled in the art.

After logging in to the account, the user may submit a request for binding the payment account to the account and the payment ID. The user may bind multiple payment accounts to the account and the payment ID. The payment account herein may be a prepaid card, an all-in-one card or the like. The user may submit payment account authentication information of the payment account, for example, a card number, a name of deposit bank or an issuing bank, a cardholder name, an identity card number, a mobile phone number or the like, to the user management platform 140. The user management platform 140 may send payment account authentication information submitted by the user, directly or indirectly by using a settlement platform 830 described below, to a payment account issuing institution such as a transaction server 850 for authentication. Examples of the payment account issuing institution include a payment account bank, a third-party payment institution, a credit card issuing institution, a prepaid card issuing institution, and an urban all-in-one card issuing institution. For example, the user management platform 140 may submit information packaged by the user to the settlement platform 830 according to a specified interface and communications protocol, and receive an authentication prompt fed back by a payment account issuing institution such as a prepaid card issuing institution or an urban all-in-one issuing institution. The payment account may include money or bonus points such as membership points.

If the authentication succeeds, the registration unit 141 may bind the account to the payment account, for example, correlate the payment ID corresponding to the account with the payment account. The user may bind multiple payment accounts to the account, and may set a default payment account, or select, at the time of paying, a corresponding payment account for payment.

Preferably, the payment identity information may further include an identity password (also called a payment password) for authenticating payment identity information. The payment password may be set by the registration unit 141 in response to a user selection. When the user forgets the payment password, the payment password may be regained or reset by using the payment account correlation information or identity information correlated with the user. The payment password may include a digital password, a gesture password, fingerprint information and the like. The account, the corresponding payment ID, the payment password, and the payment account information of at least one bound payment account may be stored in the database 143. In an instance, multiple payment accounts bound to a specific account and payment ID may be numbered 1 to N. The multiple payment accounts are stored together with the account, the payment ID, and the payment password correlatively, as shown in Table 2.

TABLE 2

| | | | | |
|---|---|---|---|---|
| Account/ | Identity (payment) | 1 | Payment | Payment account |
| payment ID | password | | account 1 | information |
| | | 2 | Payment | Payment account |
| | | | account 2 | information |
| | | . . . | . . . | . . . |
| | | N | Payment | Payment account |
| | | | account N | information |

The payment terminal 110 may implement the account registration request and password setup and the payment account binding operation by using corresponding payment software. The payment software may be installed on the payment terminal 110. For example, the user may start the payment software on the payment terminal 110, and by using the payment software, perform account registration and management, payment account binding, setup of a default payment account, payment account unbinding and the like.

The payment system 800 may further include a receiving terminal 120. The receiving terminal 120 may be a simple receiving device that is disposed at a merchant and has a signal receiving function, or may be a POS (Point of Sales) machine that has a signal receiving function and functions such as ticket printing and password input. Although FIG. 8 shows only one receiving terminal 120, more receiving terminals may be included, which should be understood by a person skilled in the art. The receiving terminal 120 may be correlated with a payment account issuing institution, and different receiving terminals are affiliated to different payment account issuing institutions. For example, the first receiving terminal is affiliated to a first payment account issuing institution, and the second receiving terminal is affiliated to a second payment account issuing institution. The payment account issuing institutions issue their respective payment accounts.

The receiving terminal 120 may be an integrated POS machine that includes a signal receiving unit. Alternatively, the receiving terminal may also be a conventional POS machine connected to a stand-alone signal receiving module. For example, the conventional POS machine may communicate with the signal receiving module by using a communications interface such as an RS232 or USB interface, or communicate with the signal receiving module by using a wireless network. The following uses a stand-alone POS machine architecture as an example to describe the receiving terminal, as shown in FIG. 1c. The receiving terminal 120 may include a signal receiving unit 122 and a POS unit 124 that performs a conventional POS function. When the payment terminal 110 is a photonic payment terminal, the signal receiving unit 122 of the receiving terminal 120 is a light receiving unit accordingly. In this case, the receiving terminal 120 may also be called a photonic receive end.

The receiving terminal 120 may communicate with the payment terminal 110 by using the signal receiving unit 122. The payment terminal 110 may include an encoding unit 112. Generally, the encoding unit 112 may encode to-be-transmitted communication data. The communication data may be any information data that needs to be transmitted by the payment terminal 110 to the receiving terminal 120, for example, payment identity information. When the payment terminal 110 is a photonic payment terminal and the receiving terminal 120 is a photonic receive end, the encoding unit 112 may encode the to-be-transmitted communication data such as the photonic identity information. Commonly known encoding may include RZ pulse count encoding. The RZ pulse count encoding is to put n bits of original information into a group, an inter-group time interval is set between two adjacent groups of signals, and the quantity of pulses in each group denotes information of n bits in this group of signals. For example, when n=2, that is, two bits combine into one group, 1, 2, 3, and 4 pulses are used to represent 00, 01, 10, and 11 respectively. Commonly known encoding may further include PPM encoding.

Preferably, the payment terminal 110 may further include an encryption unit 114. The encryption unit 114 may encrypt the communication data first, and then the encoding unit 112 performs the encoding on the encrypted communication data.

After the communication data is encoded, the signal transmitting unit 116 may send the communication data in the form of a transmitted signal, for example. When the signal transmitting unit 116 is a light emitting unit, the light emitting unit 116 may send the received encoded signal in the form of visible light by using light to represent a high-level signal and using absence of light to represent a low level.

The signal receiving unit 122 of the receiving terminal 120 may be configured to receive and process the transmitted signal that is transmitted by the signal transmitting unit 116, for example, so as to obtain communication data in the form of an electric signal. In an instance, the signal receiving unit 122 may convert, amplify, filter, and in other ways process the received transmitted signal. When the payment terminal 110 is a photonic payment terminal and the receiving terminal 120 is a photonic receive end, the light receiving unit 122 of the photonic receive end 120 may be configured to receive a visible light signal transmitted by the light emitting unit 116, and convert the visible light signal into an electric signal so as to obtain, for example, communication data in the form of an electric signal. For example, for frequent flashing generated by an LED lamp, light may represent a high level and absence of light may represent a low level, or absence of light may represent a high level and light may represent a low level. In this way, the received visible light signal can be converted into a digital signal. The light receiving unit 122 may include a light sensitive device such as a photodiode and a phototriode. An electric pulse signal is generated by using characteristics of the electric signal and the light signal of the light sensitive device and by means of optical-to-electric conversion. In practice, relative locations of the photonic payment terminal 110 to the photonic receive end 120 are different. That is, light signal intensity transmitted by each photonic payment terminal 110 to the photonic receive end 120 is different. Therefore, the electric signal strength is different, and current generated by the photodiode needs to be rectified and compared. For example, when the current value that passes through the diode is higher than a specific threshold, an optical-to-electric conversion circuit adjusts an output voltage level value to a high level; and when the current value that passes through the photodiode is lower than a specific threshold, the optical-to-electric conversion circuit adjusts the output voltage level value to a low level. The threshold is set according to different environments by using a mathematic model. For example, when a communication distance is long, the threshold may be lower; and when the distance is short, the threshold may be higher. In this way, the level can be adjusted into a specific range to ensure a correct pulse shape and maximally ensure sampling accuracy.

When the user needs to pay for consumption at a merchant, the user may use the payment terminal 110 to send the payment identity information to the receiving terminal 120 in the form of a transmitted signal such as a light signal, where the payment identity information may include a payment ID and a payment password, for example. Specifically, the encoding unit 112 may encode the payment identity information. Preferably, the encryption unit 114 may encrypt the payment identity information first, and then the encoding unit 112 encodes the encrypted payment identity information. The signal transmitting unit 116 may send a transmitted signal that indicates the encoded payment identity information.

When the user binds the payment identity information to multiple payment accounts and no default payment account is set for payment, the user may select, from the bound multiple payment accounts, a payment account used for payment. In this case, the payment identity information may carry an identifier that indicates a payment account selected for payment. For example, the identifier may indicate a serial number of the payment account when the payment account is bound.

The user may use payment software on the payment terminal 110 to start sending of the payment identity information, selection of the payment account, and the like. Before the payment function is started, the user may input a payment password. Preferably, the payment software performs a payment operation after successfully performing a preliminary authentication on the payment password.

The signal receiving unit 122 of the receiving terminal 120 may receive and process the transmitted signal that is transmitted by the payment terminal 110, so as to obtain payment identity information in the form of an electric signal. In an instance, the receiving terminal 120 may include a decoding unit for decoding the electric signal and restoring the payment identity information. In another preferred embodiment, the receiving terminal 120 does not decode the electric signal, but the POS unit 124 directly retransmits the encoded payment identity information in the form of an electric signal. In an instance, the user may input account authentication information of the payment account according to requirements after the payment identity information is sent by using the payment terminal 110. The account authentication information of the payment account is authenticated by an issuing institution (such as the transaction server) of the payment account in a subsequent payment process. The receiving terminal 120 may include an input unit 126, for example, a keyboard, a handwriting pad, a fingerprint recognition module, an iris recognition module, and a sound recognition module. The user may input the account authentication information such as a password, a signature, a fingerprint, an iris, or a sound by using the input unit 126.

The receiving terminal 120 may upload a transaction request to the settlement platform 830 after receiving the payment identity information, where the transaction request may include the payment identity information. In an instance in which the user needs to input the account authentication information of the payment account, the transaction request may further include the account authentication information. In addition, the receiving terminal 110 is generally bound to a merchant account, and therefore, the transaction request may further include information such as a merchant ID and a payment amount.

The payment system 800 may further include a settlement platform 830 to implement interaction between the receiving terminal 120, the user management platform 140, and the transaction server 850. The receiving terminal 120 may upload the transaction request to the settlement platform 830 by using a dedicated line. After receiving the settlement request, the settlement platform 830 may perform settlement based on authentication of the payment identity information.

In an instance, the settlement platform 830 may retransmit the payment identity information to the user management platform 140, and the user management platform 140 authenticates the payment identity information. The user management platform 140 may include an authentication unit 142 for performing the authentication. For example, the account of the user of the payment terminal 110 and the correlated payment identity information (for example, the payment ID and the payment password) are stored in a database 143 of the user management platform 140. In an instance in which the payment identity information includes the payment ID, the authentication unit 142 may retrieve, from the database 143, the payment ID received from the settlement platform 830; if the payment ID is not retrieved successfully, the payment identity information is illegal, and the authentication fails; or, if the payment ID is retrieved successfully, the authentication succeeds.

In an instance in which the payment identity information further includes a payment password, if the payment ID is retrieved successfully, the payment password correlated with the payment ID is further obtained, and the payment password is compared with the payment password received from the settlement platform 830. If the two passwords are same, the authentication succeeds; otherwise, the authentication fails.

In an instance, the payment identity information received by the user management platform 140 is encrypted and encoded. In this instance, the user management platform 140 may include a decoding unit 144 and a decryption unit 145. The decoding unit 144 may decode the payment identity information first, and then the decryption unit 145 performs decryption to restore the payment identity information.

In response to successful authentication, the user management platform 140 may retrieve, from the database 143, the payment account information of the payment account that is correlated with the payment identity information and used for payment, and send the payment account information of the payment account to the settlement platform 830. The user management platform 140 may be correlated with multiple payment account issuing institutions, so as to store payment account information of payment accounts issued by the multiple payment account issuing institutions. In an instance, the user sets a default payment account. In this case, the user management platform 140 may directly retrieve, in response to successful authentication, the payment account information of the payment account that is correlated with the payment identity information and used for payment by default. In another example, the user does not set a default payment account, but selects, when paying, a payment account used for payment, as mentioned above. In this case, the user payment identity information may carry an identifier that indicates a payment account used for payment. For example, the identifier may indicate a serial number of the payment account when the payment account is bound. According to the identifier, the user management platform 140 may retrieve the payment account information of the payment account used for payment. The user management platform 140 may send the retrieved payment account information of the payment account to the settlement platform 830.

In an alternative embodiment, the payment account information of the payment account may be stored in the settlement platform 830. In this embodiment, the user management platform 140 does not store the payment account information as mentioned above, but stores account correlation information that can be used to obtain the payment account information, for example, account index information. In this case, information sent by the user management platform 140 to the settlement platform 830 may be only the account correlation information used to obtain the payment account information. The settlement platform 830 may find the payment account information of the payment account in a database of the settlement platform according to the account correlation information.

In another aspect, in response to an authentication failure, the user management platform 140 may send an authentication failure message to the settlement platform 830.

The settlement platform 830 may perform settlement in response to the obtained payment account information of the payment account.

In an instance, the settlement platform 830 may send a settlement request to a corresponding transaction server 850, where the settlement request may include the payment account information of the payment account. The payment request may further include a payment amount and a merchant ID. When the user inputs the account authentication information on the receiving terminal 120, the settlement request may further include the account authentication information.

Although FIG. 8 shows only one transaction server 850, more transaction servers exist, which should be understood by a person skilled in the art. Each transaction server is correlated with a different payment account issuing institution. The settlement platform 830 may send the settlement request to the transaction server 850 corresponding to the payment account. For example, if the payment account is a prepaid card issued by a commercial institution, the transaction server 850 is a transaction server of the commercial institution accordingly. According to the payment accounts issued by different institutions, the settlement platform 830 may send a settlement request to different transaction servers 850.

Conversely, if an authentication failure message is received, the settlement platform 830 may retransmit the authentication failure message to the receiving terminal 120 to notify the merchant and the user of the payment failure.

After verifying the payment account information, the transaction server 850 may deduct an amount from the corresponding payment account according to a payment amount, and disburse the deducted amount into a transaction account of the settlement platform 830. In an instance in which the settlement request includes the account authentication information, the transaction server 850 may verify legality of the payment account information by using the account authentication information. It is noted that the transaction server 850 does not directly disburse the deducted payment amount into a merchant account, but disburses the payment amount into a transaction account opened at the bank for the settlement platform 830. The settlement platform 830 performs settlement with the merchant periodically. Therefore, payment is deemed successful once the settlement platform 830 receives the payment amount transferred by the transaction server 850. After the transfer, the transaction server 850 may feed back the payment settlement information such as a payment account number and a deducted amount to the settlement platform 830. The settlement platform 830 may retransmit the payment settlement information to the receiving terminal 120.

In this way, the user can complete transaction payment by using the payment terminal 110.

According to the solution of the present disclosure, the user does not need to carry numerous payment cards, and can implement payment by using a mobile phone that has a signal transmitting function. In addition, because some payment cards have no payment account password and are vulnerable to theft once the cards are lost, the payment account is bound to the account in the present disclosure, and a payment password is set to effectively prevent theft of the payment account.

In addition, even if some payment accounts have a payment account password, the user usually needs to modify the payment account password to prevent loss of the payment account. In this case, the user needs to log in to a website of the merchant that issues the payment account, get registered first, and then modify the payment account password, which involves very complicated operations. In the present disclosure, the user can bind the payment account to the account after the user is authenticated by the card issuing institution at a single attempt. When using the payment account later, the user can pass authentication and perform corresponding payment by using a uniform payment password that is set by the user for the account. The user does not need to modify the payment account password for each payment account any more, and all the user needs to do it to remember the payment password.

In addition, in a conventional offline card swiping payment, account information of a payment account is vulnerable to theft. However, according to the solution in the present disclosure, the POS end does not transmit the account information of the payment account, so that security is improved significantly.

FIG. 9 is a flowchart of a payment method 900 according to one aspect of the present disclosure.

In step 902, a payment terminal sends payment identity information to a receiving terminal in the form of a transmitted signal.

In an instance, the payment terminal may encode the payment identity information, and send the encoded payment identity information to the receiving terminal in the form of a transmitted signal. Preferably, the payment terminal may encrypt the payment identity information first, and then encode the encrypted payment identity information. The receiving terminal receives and processes the transmitted signal to obtain an electric signal, so as to obtain payment identity information in the form of an electric signal.

In an instance, the payment identity information may include a payment ID. Preferably, the payment identity information may further include a payment password.

In step 904, the receiving terminal sends a transaction request to a settlement platform, where the transaction request may include the payment identity information.

In an instance in which the user needs to input the account authentication information of the payment account, the transaction request may further include the account authentication information. In addition, the receiving terminal is generally bound to a merchant account, and therefore, the transaction request may further include information such as a merchant ID and a payment amount.

In step 906, the settlement platform may perform settlement based on authentication of the payment identity information.

In an instance, the settlement platform may retransmit the payment identity information to the user management platform, and the user management platform may authenticate the received payment identity information. In an instance, the payment identity information includes a payment ID. The user management platform may retrieve the received payment ID from the database of the user management platform. If the payment ID is not retrieved successfully, the payment identity information is illegal, and the authentication fails. If the payment ID is retrieved successfully, the authentication succeeds. Preferably, when the payment ID is retrieved successfully, the user management platform may further obtain a payment password correlated with the payment ID, and compare the payment password with the received payment password. If the two passwords are same, the authentication succeeds; otherwise, the authentication fails.

In an instance, the payment identity information received by the user management platform is encrypted and encoded. In this instance, the user management platform may decode the payment identity information first, and then perform decryption to restore the payment identity information.

In response to successful authentication, the user management platform may send the payment account information to the settlement platform, where the payment account information is information about the payment account used for payment, for example, the first payment account. In an alternative embodiment, the user management platform may send account correlation information of the payment account information, where the account correlation information is available to the settlement platform for finding the payment account information. In an instance, the first payment account is a default payment account. In this case, the user management platform may directly retrieve, in response to successful authentication, the payment account information of the first payment account that is correlated with the payment identity information and used for payment by default. In another instance, no default payment account is set by the user. In this case, the payment identity information may carry an identifier that indicates the first payment account. According to the identifier, the user management platform may retrieve the payment account information of the first payment account correlated with the payment identity information. The settlement platform may perform settlement in response to the received payment account information.

In response to an authentication failure, the user management platform may send an authentication failure message to the settlement platform. The settlement platform may retransmit the authentication failure message to the receiving terminal in response to the received authentication failure message.

In an instance, the settlement platform may send a settlement request to a transaction server corresponding to the first payment account, where the settlement request may include the payment account information of the first payment account. The settlement request may further include a payment amount. The transaction server may deduct an amount from the first payment account according to the payment amount, disburse the deducted amount into a transaction account of the settlement platform, and feed back payment settlement information to the settlement platform. The settlement platform may retransmit the payment settlement information to the receiving terminal in response to the received payment settlement information.

To simplify interpretation, the foregoing methods are illustrated and described as a series of actions. However, it should be understood that the methods are not limited by order of the actions because, according to one or more embodiments, some actions may occur in different order or may concurrently occur together with actions illustrated and described herein or actions that are not illustrated or described herein but understandable by a person skilled in the art.

A person skilled in the art is further aware that, various illustrative logical boards, modules, circuits and algorithm steps described with reference to the embodiments disclosed herein may be implemented as electronic hardware or computer software or a combination thereof. In order to clearly describe interchangeability between hardware and software, various illustrative components, frames, modules, circuits, and steps are generically described above in the form of their functionality. Whether the functionality is implemented as hardware or software depends on specific application and design constraints applied to an overall system. A person skilled in the art may implement the described functionality for each specific application in different manners, but it should not be considered that the implementation goes beyond the scope of the present disclosure.

Various illustrative boards, modules, and circuits described in the embodiments disclosed herein may be implemented or executed by a general purpose processor, a digital signal processor (DSP), an application-specific integrated circuit (ASIC), a field programmable gate array, or other programmable logic devices, discrete gates or transistor logics, discrete hardware devices, or any combination designed to implement functions described herein. The general purpose processor may be a microprocessor, but in an alternative solution, the processor may be any conventional processor, control, microcontroller, or state machine. The processor may also be implemented as a combination of computing devices, such as a combination of a DSP and a microprocessor, multiple microprocessors, one or more microprocessors that collaborate with a DSP core, or any other similar configurations.

The steps of methods or algorithms described with reference to the embodiments disclosed herein may be reflected directly in hardware, a software module executed by a processor, or a combination thereof. The software module may camp on a RAM memory a flash memory, a ROM memory, an EPROM memory, an EEPROM memory, a register, a hard disk, a movable disk, a CD-ROM, or any other forms of storage medium known in the art. An exemplary storage medium is coupled to a processor so that the processor can read and write information into/from the storage medium. In an alternative solution, the storage medium may be integrated into the processor. The processor and the storage medium may camp on the ASIC. The ASIC may camp on a user terminal. In an alternative solution, the processor and the storage medium may camp on a user terminal as stand-alone components.

In one or more exemplary embodiments, the described functions may be implemented in hardware, software, firmware, or any combination thereof. If the functions are implemented in software as a computer program product, each function may be stored as one or more instructions or code in a computer-readable medium or transferred by means of it. The computer-readable medium includes a computer storage medium and a communication medium, and includes any medium that causes transfer of a computer program from one place to another. The storage medium may be any available medium that can be accessed by a computer. Exemplarily rather than restrictively, the computer-readable medium may include: RAM, ROM, EEPROM, CD-ROM or other optical disk storage, magnetic disk storage or other magnetic storage devices, or any other medium that can be used to carry or store any program code in the form of instructions or data structures and can be accessed by a computer. Any connection is also properly called a computer-readable medium. For example, if software is transferred by using a coaxial cable, an optical cable, a twisted pair, a digital subscriber line (DSL), or transferred from a website, a server or other remote sources by using wireless technologies such as infrared, radio, and microwave, the coaxial cable, optical cable, and twisted pair, DSL, or the wireless technologies such as infrared, radio, and microwave are included in the definition of the medium. The disk (disk) and disc (disc) used herein include compressed disk (CD), laser disk, optical disk, digital versatile disc (DVD), floppy disk and Blu-ray disc, where the disk (disk) generally re-presents data in a magnetic form, and the disc (disc) re-presents data in an optical form by using laser. A combination thereof should also be included the scope of the computer-readable medium.

Prior description of this disclosure is provided in order to enable any person skilled in the art to make or use this disclosure. Various modifications made to this disclosure are apparent to a person skilled in the art, and general principles defined herein may be applied to other variants without departing from the spirit or scope of this disclosure. Therefore, this disclosure is not intended to being limited to the examples and design described herein, but shall meet the widest scope that matches the principles and novel features disclosed herein.

What is claimed is:

1. A payment method, comprising:
sending, by a payment terminal, identity information to a receiving terminal in the form of a transmitted signal;
sending, by the receiving terminal, transaction information to an acquiring platform, the transaction information comprising the identity information;
obtaining, by the acquiring platform, payment account information based on the identity information, and sending a payment request to a settlement platform, the payment account information being information about a first payment account used for payment; and
performing, by the settlement platform, settlement in response to the payment request, the payment request comprising the payment account information of the first payment account.

2. The payment method according to claim 1, wherein the obtaining, by the acquiring platform, payment account information based on the identity information, the payment account information being information about a first payment account used for payment specifically comprises:
retransmitting, by the acquiring platform, the identity information to a user management platform, comprising:
retransmitting, by the acquiring platform, the identity information in the form of an electric signal to the user management platform; and
decoding, by the user management platform, the electric signal, and decrypting the decoded electric signal to obtain the identity information;
authenticating, by the user management platform, the identity information;
sending, by the user management platform, the payment account information of the first payment account or account correlation information of the payment account information to the acquiring platform if the authentication succeeds, when the first user management platform sending the payment account information of the first payment account or account correlation information of the payment account information to the acquiring platform, the method further comprising: finding, by the acquiring platform, the payment account information of the first payment account from the database of the acquiring platform based on the account correlation information of the payment account information;
sending, by the user management platform, an authentication failure message to the acquiring platform if the authentication fails; and
retransmitting, by the acquiring platform, the authentication failure message to the receiving terminal in response to the received authentication failure message.

3. The payment method according to claim 2, wherein the user management platform is correlated with multiple financial institutions comprising a first financial institution that issues the first payment account, and payment account information of payment accounts issued by the multiple financial institutions is stored in the user management platform;
the acquiring platform and the user management platform are correlated with the first financial institution, and payment account information of all payment accounts issued by the first financial institution are stored in the user management platform, wherein the retransmitting, by the acquiring platform, the identity information in the form of an electric signal to the user management platform, comprises:
sending, by the acquiring platform, the identity information to the user management platform in response to judgement that the first payment account is a payment account issued by the first financial institution.

4. The payment method according to claim 2, wherein the identity information comprises an identity ID, and the authenticating, by the user management platform, the identity information comprises:
retrieving, by the user management platform, the identity ID from a database;
if the identity ID is not retrieved, the authentication fails; or
if the identity ID is retrieved, comparing a payment password correlated with the identity ID in the database with a payment password received from the acquiring platform; and if the two passwords are same, the authentication succeeds; otherwise, the authentication fails.

5. The payment method according to claim 2, wherein the first payment account is a default payment account, and the sending, by the user management platform, the payment account information of the first payment account to the acquiring platform specifically comprises:
retrieving, by the user management platform, directly in response to successful authentication, the payment account information of the first payment account that is correlated with the identity information and used for payment by default; or the identity information further carries an identifier that indicates the first payment account, and the sending, by the user management platform, the payment account information of the first payment account to the acquiring platform specifically comprises:
retrieving, by the user management platform, the payment account information of the first payment account according to the identifier.

6. The payment method according to claim 1, wherein the performing, by the settlement platform, settlement in response to the received payment request comprises:
sending, by the settlement platform, a settlement request to a payment transaction server corresponding to the first payment account in response to the payment request, wherein the settlement request comprises the payment account information of the first payment account; and
disbursing, by the payment transaction server, a payment amount into a transaction account of the settlement platform, and feeding back payment settlement information to the settlement platform;
retransmitting, by the settlement platform, the payment settlement information to the acquiring platform;
sending, by the acquiring platform, the payment settlement information to the user management platform and the receiving terminal; and
feeding back, by the user management platform, the payment settlement information to the payment terminal.

7. The payment method according to claim 1, wherein the performing, by the settlement platform, settlement in response to the received payment request comprises:
sending, by the settlement platform, a settlement request to the payment transaction server in response to the payment request, wherein the settlement request comprises the payment account information of the first payment account;
executing, by the payment transaction server, a payment transaction based on the settlement request from the settlement platform and confirmation information from the payment terminal, wherein the confirmation information comprises a payment transaction password of the first payment account; executing, by the payment transaction server, the payment transaction if the payment transaction password is correct, or feeding back a failure notification message to the settlement platform and the payment terminal if the payment transaction password is incorrect; and
the method further comprises:
sending, by the payment transaction server, a confirmation request to the payment terminal; and
sending, by the payment terminal, confirmation information to the payment transaction server in response to the confirmation request.

8. A payment method, comprising:
sending, by a payment terminal, identity information to a receiving terminal in the form of a transmitted signal;
sending, by the receiving terminal, transaction information to an acquiring platform, wherein the transaction information comprises the identity information;
obtaining, by a settlement platform, payment account information based on the identity information from the acquiring platform, wherein the payment account information is information about a first payment account used for payment; and
performing, by the settlement platform, settlement in response to the obtained payment account information of the first payment account.

9. The method according to claim 8, wherein the obtaining, by a settlement platform, payment account information based on the identity information from the acquiring platform, wherein the payment account information is information about a first payment account used for payment comprises:
retransmitting, by the settlement platform, the identity information to a first user management platform;
authenticating, by the first user management platform, the identity information;
sending, by the first user management platform, the payment account information of the first payment account or account correlation information of the payment account information to the settlement platform if the authentication succeeds, when the first user management platform sending the payment account information of the first payment account or account correlation information of the payment account information to the settlement platform, the method further comprising: finding, by the settlement platform, the payment account information of the first payment account from the database of the settlement platform based on the account correlation information of the payment account information;
sending, by the first user management platform, an authentication failure message to the settlement platform if the authentication fails; and
retransmitting, by the settlement platform, the authentication failure message to the acquiring platform in response to the received authentication failure message, and feeding back, by the acquiring platform, the authentication failure message to the receiving terminal.

10. The payment method according to claim 9, wherein the first user management platform is correlated with a first financial institution that issues the first payment account, and payment account information of a payment account issued by the first financial institution is stored in the first user management platform; or the first user management platform is correlated with multiple financial institutions comprising a first financial institution that issues the first payment account, and payment account information of payment accounts issued by the multiple financial institutions is stored in the first user management platform.

11. The payment method according to claim 9, wherein the identity information comprises an identity ID, and the authenticating, by the first user management platform, the identity information comprises:
retrieving, by the first user management platform, the identity ID from a database;
if the identity ID is not retrieved, the authentication fails; or
if the identity ID is retrieved, comparing a payment password correlated with the identity ID in the database with a payment password received from the settlement platform; and if the two passwords are same, the authentication succeeds; otherwise, the authentication fails.

12. The payment method according to claim 9, wherein the first payment account is a default payment account, and the sending, by the first user management platform, the payment account information of the first payment account to the settlement platform specifically comprises:
retrieving, by the first user management platform, directly in response to successful authentication, the payment account information of the first payment account that is correlated with the identity information and used for payment by default; or the identity information further carries an identifier that indicates the first payment account, and the sending, by the first user management platform, the payment account information of the first payment account to the settlement platform specifically comprises:
retrieving, by the first user management platform, the payment account information of the first payment account according to the identifier.

13. The payment method according to claim 8, wherein the performing, by the settlement platform, settlement in response to the obtained payment account information comprises:
sending, by the settlement platform, a settlement request to a payment transaction server corresponding to the first payment account, wherein the settlement request comprises the payment account information of the first payment account; and
disbursing, by the payment transaction server, a payment amount into a transaction account of the settlement platform, and feeding back payment settlement information to the settlement platform; and
retransmitting, by the settlement platform, the payment settlement information to the acquiring platform, and sending, by the acquiring platform, the payment settlement information, to the receiving terminal.

14. The payment method according to claim 8, wherein the acquiring platform and a second user management platform that is communicationally coupled with the acquiring platform are correlated with a second financial institution, and payment account information of a payment account issued by the second financial institution is stored in the second user management platform, and the method further comprises:
sending, by the acquiring platform, a payment request to the settlement platform in response to a judgment that the first payment account is not a payment account issued by the second financial institution, wherein the payment request comprises the identity information.

15. A payment method, comprising:
sending, by a payment terminal, payment identity information to a receiving terminal in the form of a transmitted signal;
sending, by the receiving terminal, a transaction request to a settlement platform, wherein the transaction request comprises the payment identity information; and
performing, by the settlement platform, settlement based on authentication of the payment identity information.

16. The payment method according to claim 15, wherein the performing, by the settlement platform, settlement based on authentication of the payment identity information specifically comprises:
retransmitting, by the settlement platform, the payment identity information to a user management platform, comprising:
retransmitting, by the settlement platform, the payment identity information that is from the receiving terminal and in the form of an electric signal to the user management platform; and
decoding, by the user management platform, the electric signal, and decrypting the decoded electric signal to obtain the payment identity information;
authenticating, by the user management platform, the payment identity information;
sending, by the user management platform, payment account information of a first payment account used for payment or account correlation information of the payment account information to the settlement platform if the authentication succeeds, when the first user management platform sending the account correlation information of the payment account information of the first payment account to the settlement platform, the method further comprising: finding, by the settlement platform, the payment account information of the first payment account from the database of the settlement platform based on the account correlation information; and
performing, by the settlement platform, settlement in response to the obtained payment account information of the first payment account;
sending, by the user management platform, an authentication failure message to the settlement platform if the authentication fails; and
retransmitting, by the settlement platform, the authentication failure message to the receiving terminal in response to the received authentication failure message.

17. The payment method according to claim 16, wherein the performing, by the settlement platform, settlement specifically comprises:
sending, by the settlement platform, a settlement request to a transaction server corresponding to the first payment account, wherein the settlement request comprises the payment account information of the first payment account; and
deducting, by the transaction server, an amount from the first payment account according to a payment amount, and disbursing the deducted amount into a transaction account of the settlement platform;
feeding back, by the transaction server, payment settlement information to the settlement platform after the deducting; and
retransmitting, by the settlement platform, the payment settlement information to the receiving terminal.

18. The payment method according to claim 16, wherein the payment identity information comprises a payment ID, and the authenticating, by the user management platform, the payment identity information comprises:
retrieving, by the user management platform, the payment ID from a database;
if the payment ID is not retrieved, the authentication fails; or
if the payment ID is retrieved, comparing a payment password correlated with the payment ID in the database with a payment password received from the settlement platform; and if the two passwords are same, the authentication succeeds; otherwise, the authentication fails.

19. The payment method according to claim 16, wherein the first payment account is a default payment account, and the sending, by the user management platform, the payment account information of the first payment account to the settlement platform specifically comprises:
retrieving, by the user management platform, directly in response to the received payment identity information, the payment account information of the first payment account that is correlated with the payment identity information and used for payment by default; or
the payment identity information carries an identifier that indicates the first payment account, and the sending, by the user management platform, the payment account information of the first payment account to the settlement platform specifically comprises:
retrieving, by the user management platform, the payment account information of the first payment account according to the identifier.
